(19) United States
(12) Patent Application Publication
(10) Pub. No.: US 2026/0304536 A1
(43) Pub. Date: Oct. 1, 2026

(54) WIRELESS LINK MODE CONTROL OFFLOADING

(71) Applicant: Synaptics Incorporated, San Jose, CA (US)

(72) Inventor: Kai-Hsin Chung, Taipei (TW)

(73) Assignee: Synaptics Incorporated, San Jose, CA (US)

(21) Appl. No.: 19/566,908

(22) Filed: Mar. 13, 2026

Related U.S. Application Data
(60) Provisional application No. 63/780,836, filed on Mar. 31, 2025.

(51) Int. Cl. H04W 76/20; H04W 4/80; H04W 24/08; H04W 76/10

(52) U.S. Cl. CPC H04W 76/20; H04W 4/80; H04W 24/08; H04W 76/10

(57) ABSTRACT

This disclosure provides methods, devices, and systems for controlling a mode of operation associated with a wireless communication link. In some implementations, a controller module of a first wireless communication device may establish a link with a second wireless communication device; switch between an active mode associated with the link and a sniff mode associated with the link without sending to a host module of the first wireless communication device a message associated with the switching between the active mode and the sniff mode; determine that the link is idle for at least a threshold duration; and in response to determining that the link is idle for at least the threshold duration, switch a mode of operation associated with the link, from an active mode to a sniff mode, without sending to the host module a message associated with the switching to the sniff mode.

### CROSS-REFERENCE TO RELATED APPLICATIONS

This application claims the benefit of U.S. Provisional Application No. 63/780,836, titled “WIRELESS LINK MODE CONTROL OFFLOADING” and filed on Mar. 31, 2025, which is incorporated herein by reference in its entirety.

### TECHNICAL FIELD

The present implementations relate generally to wireless communications, and more particularly to offloading of mode control associated with a wireless communication link.

### BACKGROUND OF RELATED ART

Many wireless communication devices are capable of wireless communications using a variety of short range wireless communication protocols. For example, many cellular phones, and other mobile computing devices may use the Bluetooth communication protocol to communicate with devices such as speakers, microphones, sensors, headsets, keyboards, or mice, among other examples. In addition, many mobile computing devices are powered by batteries, and may operate in a reduced power mode in order to conserve power. For example, some mobile computing devices may be capable of entering a sleep mode, also referred to as “suspend to RAM” (random access memory), which can significantly reduce power consumption of the mobile computing device while enabling the device to quickly resume operations upon exiting the sleep mode (such as without reissuing instructions or waiting for the device to fully boot).

### SUMMARY

This Summary is provided to introduce in a simplified form a selection of concepts that are further described below in the Detailed Description. This Summary is not intended to identify key features or essential features of the claims subject matter, nor is it intended to limit the scope of the claimed subject matter.

A method and a device are disclosed. One innovative aspect of the subject matter of this disclosure can be implemented in a method performed by establishing a link with a second wireless communication device; switching between an active mode associated with the link and a sniff mode associated with the link without sending to a host stack of the first wireless communication device a message associated with the switching between the active mode and the sniff mode; determining that the link is idle for at least a threshold duration; and in response to determining that the link is idle for at least the threshold duration, switching a mode of operation associated with the link, from an active mode to a sniff mode, without sending to the host stack of the first wireless communication device a message associated with the switching to the sniff mode.

Another innovative aspect of the subject matter of this disclosure can be implemented in a first wireless communication device comprising a host module and a controller module. The controller module is configured to a controller module configured to establish a link with a second wireless communication device; switch between an active mode associated with the link and a sniff mode associated with the link without sending to the host module a message associated with the switching between the active mode and the sniff mode; determine that the link is idle for at least a threshold duration; and in response to determining that the link is idle for at least the threshold duration, switch a mode of operation associated with the link, from an active mode to a sniff mode, without sending to the host module a message associated with the switching to the sniff mode.

### BRIEF DESCRIPTION OF THE DRAWINGS

The present implementations are illustrated by way of example and are not intended to be limited by the figures of the accompanying drawings.

FIG. 1 shows a block diagram of an example computing system within which aspects of the present disclosure may be implemented.

FIG. 2 shows an example messaging diagram depicting messages associated with entry into a sniff mode according to a wireless communication protocol.

FIG. 3 shows an illustrative flow chart depicting an example operation for configuring a device to offload mode control to a controller, according to some implementations.

FIG. 4 shows an illustrative diagram depicting an example operation for a controller switching between an active mode and a sniff mode for a Bluetooth link, according to some implementations.

FIG. 5 shows a block diagram of an example wireless communication device, according to some implementations.

FIG. 6 shows an illustrative flowchart depicting an example operation for controlling a mode of operation of a wireless communication link, according to some implementations.

### DETAILED DESCRIPTION

In the following description, numerous specific details are set forth such as examples of specific components, circuits, and processes to provide a thorough understanding of the present disclosure. The term “coupled” as used herein means connected directly to or connected through one or more intervening components or circuits. The terms “electronic system” and “electronic device” may be used interchangeably to refer to any system capable of electronically processing information. Also, in the following description and for purposes of explanation, specific nomenclature is set forth to provide a thorough understanding of the aspects of the disclosure. However, it will be apparent to one skilled in the art that these specific details may not be required to practice the example embodiments. In other instances, well-known circuits and devices are shown in block diagram form to avoid obscuring the present disclosure. Some portions of the detailed descriptions which follow are presented in terms of procedures, logic blocks, processing and other symbolic representations of operations on data bits within a computer memory.

These descriptions and representations are the means used by those skilled in the data processing arts to most effectively convey the substance of their work to others skilled in the art. In the present disclosure, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system. It should be borne in mind, however, that all of these and similar terms are to be associated with the appropriate physical quantities and are merely convenient labels applied to these quantities.

Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving” or the like, refer to the actions and processes of a computer system, or similar electronic computing device, that manipulates and transforms data represented as physical (electronic) quantities within the computer system’s registers and memories into other data similarly represented as physical quantities within the computer system memories or registers or other such information storage, transmission or display devices.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, circuits, and steps have been described below generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example input devices may include components other than those shown, including well-known components such as a processor, memory and the like.

The techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium including instructions that, when executed, perform one or more of the methods described above. The non-transitory processor-readable data storage medium may form part of a computer program product, which may include packaging materials.

The non-transitory processor-readable storage medium may comprise random access memory (RAM) such as synchronous dynamic random-access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

The various illustrative logical blocks, modules, circuits and instructions described in connection with the embodiments disclosed herein may be executed by one or more processors (or a processing system). The term “processor,” as used herein may refer to any general-purpose processor, special-purpose processor, conventional processor, controller, microcontroller, and/or state machine capable of executing scripts or instructions of one or more software programs stored in memory.

A device paired to another device via wireless communication link may operate the link in certain modes that are distinct from device-wide reduced power modes (e.g., the above-described sleep mode). For example, for a wireless link established according to the Bluetooth communications protocol, the device may operate the link in a sniff mode. When the device operates the link in sniff mode, the device operates the link on a reduced duty cycle (e.g., listening at a reduced rate, minimizing certain transmissions) as compared to an active mode for the link. By operating a link in sniff mode, the device may reduce power consumption associated with operating that link.

The Bluetooth protocol may be implemented as a stack of protocol layers, where layers below a certain level of the stack are referred to as the “controller” (or “controller layer(s),” “controller stack”) and the remaining layers of the stack are referred to as the “host” (or “host layer(s),” “host stack”). The host is responsible for performing higher-level tasks, such as searching for nearby devices, data management, and deciding the mode of operation for a link. The controller is responsible for performing lower-level tasks such as transmitting and receiving data, and controlling the physical hardware (e.g., radio transmitter) used for those lower-level tasks. “Host” and “controller” may also refer to the hardware and/or software units or modules implementing those respective layers of the protocol stack.

A host of a device may initiate entry into a sniff mode for a link by sending a request for sniff mode to the controller of the device. The controller communicates with a controller at the device opposite the link to put the link into sniff mode, while the host waits for confirmation of the mode change event from the controller. While the host waits for confirmation from the controller, the device is prevented from entering a sleep mode. In some instances, the controller of the device may receive a request to enter a sniff mode for a link from a paired device on the opposite side of the link, while the device is in sleep mode. In order to handle the request, the device may need to exit the sleep mode. In these situations, the inability to enter sleep mode while a sniff mode request is pending and/or the interruption of the sleep mode can reduce the power savings to the device from entering into sleep mode.

As described above, many wireless computing devices, such as cellular phones, tablet computers, laptops, and so on, are capable of communicating using a variety of short-range wireless communication protocols, such as Bluetooth, Bluetooth Low Energy (BLE), Wi-Fi, Near-Field Communication (NFC), Zigbee, Z-Wave, or Ultra-Wideband (UWB). Such wireless computing devices may include one or more central processing units, related memory and memory interfaces, input/output devices and interfaces, and storage interfaces. For example, such devices and functionality can be implemented in one or more system-on-chip (SoC) integrated circuits. Such wireless computing devices can also include one or more modules configured to control communications in accordance with a short-range wireless communication protocol, such as a Bluetooth module for controlling communications in accordance with Bluetooth-related protocols.

Because such wireless computing devices are often powered by batteries, power consumption is a particularly important consideration. Such computing devices may be capable of entering a sleep mode (e.g., suspend to RAM or random access memory) to conserve power. This sleep mode can significantly reduce power consumption of the wireless computing device while enabling the device to resume operations without requiring reissuing instructions or waiting for the device to fully boot. Further, such devices may also be capable of entering into certain power saving modes related to wireless communications. For example, a device may enter a sniff mode with respect to a Bluetooth link, which may reduce power consumption associated with the link by reducing a frequency at which the device listens for communications on the link.

In some instances, a device may be hindered from entering a sleep mode, or forced to exit a sleep mode, in order to enter into a sniff mode for a link. For example, if a device is attempting to enter into a sniff mode for a Bluetooth link, the device is hindered from entering into a sleep mode while waiting for confirmation of entry into the sniff mode. As another example, a device that, while in sleep mode, receives a request to enter into a sniff mode for a Bluetooth link (e.g., from another device paired via the Bluetooth link) may need to exit the sleep mode to handle the request. In these cases, operation of the host layers involved in handling the entry into sniff mode may require the device to be awake (e.g., not in sleep mode). Such operation of the host layers thus may result in a reduction in power savings that may be obtained from implementing a sleep mode due to the device being hindered from entering into or remaining in sleep mode.

Various aspects relate generally to techniques for reducing power consumption for wireless communications. More specifically, aspects of the present disclosure relate to offloading mode control for a wireless link (e.g., a Bluetooth link) from a host module to a controller module of the device. For example, a first device may establish a link with a second device. A host module of the first device may configure a controller module of the first device to control the mode of operation for the link, instead of the host module controlling the mode of the operation for the link. The controller module of the first device may determine that a link has been idle or inactive (e.g., no data transmitted over the link) for at least a threshold duration. Based on the determination that the link has been idle for at least the threshold duration, the controller module may change the mode of operation for the link from the active mode to the sniff mode.

Particular implementations of the subject matter described in this disclosure can be implemented to realize one or more of the following potential advantages. Aspects of the present disclosure may allow a wireless communication device to enter and/or exit a sniff mode on a wireless link without involvement by a host stack of the device. This allows the device to enter into or remain in a sleep mode, without disrupting the sleep mode in order to have the host stack process the switch to or from the sniff mode. Accordingly, the disclosed techniques can improve the power savings to the device by allowing the device to go into sleep mode while a sniff mode request is pending and/or to remain in sleep mode for longer periods of time.

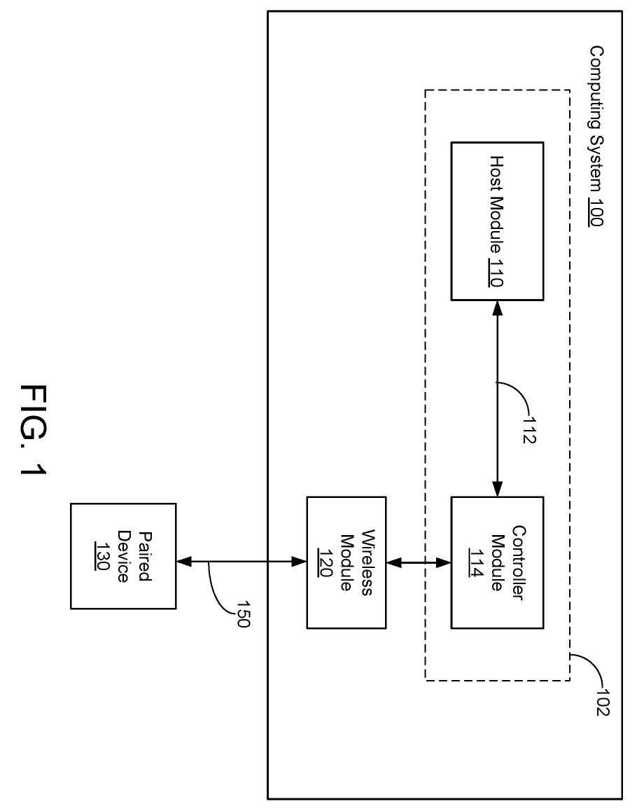

FIG. 1 shows a block diagram of an example computing system 100 within which aspects of the present disclosure may be implemented. The computing system 100 includes a wireless communication core 102 and a short range wireless module 120 which may be wirelessly coupled to a paired device 130. In some implementations, the computing system 100 may be a device such as a cellular phone, a smartphone, a tablet computer, a laptop computer, a desktop computer, television set top box, game console, or any other computing device capable of wireless communication using one or more short range wireless communication protocols such as Bluetooth.

The wireless communication core 102 is configured to perform wireless connectivity and communication functions of the computing system 100 according to a wireless communication protocol. In some implementations, the wireless communication core 102 performs wireless connectivity and communication functions according to the Bluetooth wireless communication protocol. The wireless communication core 102 includes a host module 110 and a controller module 114. The host module 110 implements a host stack of the wireless communication protocol. In some aspects, the host module 110 implements the host stack of the Bluetooth wireless communication protocol. In some implementations, the host stack includes one or more network and transport protocols that enable applications to communicate with other devices (e.g., a paired device 130). Examples of protocols that may be included in the host stack include a service discovery protocol, a telephone control protocol, an audio/video control transport protocol, and so on. The host module 110 may be implemented on hardware, software, or a combination of both hardware and software. For example, the host module 110 may be implemented within an application or an operating system (e.g., Windows, macOS, iOS, Android, etc.) that may be executed by a processor of the computing system 100. As another example, the host module 110 may be implemented in an integrated circuit (e.g., a chip, a system-on-chip (SOC)) within the computing system 100.

The controller module 114 implements a controller stack of the wireless communication protocol. In some aspects, the controller module 114 implements the controller stack of the Bluetooth wireless communication protocol. In some implementations, the controller stack includes one or more protocols that provides, in conjunction with the short range wireless module 120, wireless communication capability. Examples of protocols that may be included in the controller stack include an asynchronous connection-oriented logical transport (ACL) protocol, a link management protocol, and a link layer. The controller module 114 may be implemented on hardware, software, or a combination of both hardware and software. For example, the controller module 114 may be implemented in an integrated circuit (e.g., a chip, an SoC) within the computing system 100. In some implementations, the host module 110 and the controller module 114 may be combined (e.g., within the same SoC).

The host module 110 and the controller module 114 may communicate via a host controller interface (HCI) 112. The HCI 112 may implement a protocol by which the host stack in the host module 110 and the controller stack in the controller module 114 may communicate with each other. Additionally, in some implementations, the host module 110 and the controller module 114 may implement one or more vendor-specific commands that may extend the features or functionality of the wireless communication protocol but are not part of a standard or technical specification associated with the wireless communication protocol.

The short range wireless module 120 may be wirelessly coupled to one or more paired devices 130. For example, a paired device 130 may be any suitable peripheral device such as a remote control, smart light switch, garage door opener, speaker, microphone, or another peripheral device coupled to the computing system 100. In some implementations, the short range wireless module 120 includes a radio transmitter and other hardware that may be used to establish a wireless link 150 with the device 130 based on the wireless communication protocol (e.g., Bluetooth) in order to pair with the device 130. In some implementations, the controller module 114 and the short range wireless module 120 may be combined (e.g., on the same integrated circuit or chip). In some implementations, the paired device 130 may be a computing device or system similar to the computing system 100 (e.g., the paired device 130 also includes a wireless communication core 102 and a short range wireless module 120, as with the computing system 100).

In some implementations, the computing system 100, in particular the wireless communication core 102, may operate the wireless link 150 in certain modes associated with the wireless communication protocol (e.g., Bluetooth). For example, the computing system 100 may operate a Bluetooth wireless link 150 in an active mode or a sniff mode (among a number of modes defined by the Bluetooth protocol standard). In the active mode, the computing system 100 may actively listen on the link 150 for transmissions, and may actively send and/or receive data and/or control packets over the link 150. In the sniff mode, the computing system 100 may listen on the link 150 at a lower frequency than in active mode, and is not actively sending and/or receiving data and/or control packets over the link 150. For example, the computing system 100 may switch the link 150 from an active mode to a sniff mode if the link 150 is inactive or idle (e.g., no data transmissions) for at least a threshold duration of time. In some implementations, in sniff mode, the computing system 100 operates the link 150 with reduced power consumption as compared to the power consumption in active mode.

It should be appreciated that while the techniques described herein are described with reference to the Bluetooth wireless communication protocol, the described techniques may also be applicable to other wireless communication protocols with a similar protocol stack structure (e.g., one or more host layers and one or more controller layers) as Bluetooth.

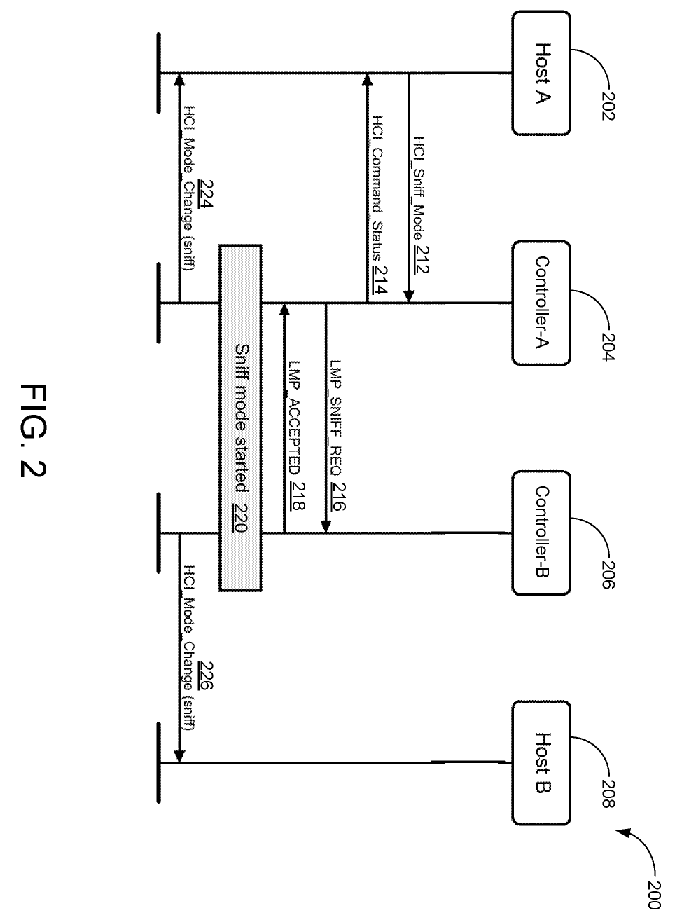

FIG. 2 shows an example messaging diagram depicting messages associated with entry into a sniff mode according to a wireless communication protocol. According to the Bluetooth standard, the host stack may detect a condition for switching the mode of operation of a link from active mode to sniff mode and to initiate that switch. The process of switching to the sniff mode includes various communications transmitted between the host stack and the controller stack within a device (e.g., within the computing system 100 or the paired device 130), and communications transmitted between devices (e.g., between the computing system 100 and the paired device 130). FIG. 2 depicts a messaging sequence 200, as specified by the Bluetooth standard, for switching a link (e.g., link 150) to a sniff mode.

As shown, the messaging sequence 200 involves a “Host A” 202, “Controller-A” 204, “Controller-B” 206, and “Host B” 208. “Host A” 202 and “Controller-A” 204 correspond to a host stack and a controller stack, respectively, of a first device (e.g., computing system 100). “Controller-B” 206 and “Host B” 208 correspond to a controller stack and a host stack, respectively, of a second device (e.g., paired device 130) paired with the first device (e.g., via a wireless communication link such as wireless link 150). In some implementations, Host A 202 and Controller-A 204 may be examples of the host module 110 and the controller module 114, respectively, of the computing system 100. In some implementations, Controller-B 206 and Host B 208 may be examples of a controller module (similar to controller module 114) and a host module (similar to host module 110), respectively, of the paired device 130.

In some implementations, the Host A 202 may detect a condition on the link, being operated in active mode, that meets a condition for switching the link from the active mode to a sniff mode. For example, the Host A 202 may detect a lack of activity (e.g., no incoming data from or outgoing data to the second device, idleness or inactivity) on the link for at least a threshold duration. Based on the detection of the condition for switching to sniff mode (e.g., inactivity on the link for at least the threshold duration), Host A 202 may initiate a switch to sniff mode for the link. Thus, the Host A 202 may send an HCI_Sniff_Mode message 212 to the Controller-A 204. The HCI_Sniff_Mode message 212 is a request, sent via an HCI (e.g., HCI 112), to request entering into sniff mode for the link. In some implementations, the HCI_Sniff_Mode message specifies one or more standard-defined parameters associated with the sniff mode, including an identifier (e.g., a “connection handle”) of the link for which the sniff mode is being requested. The HCI_Sniff_Mode message may further include one or more parameters specifying certain intervals, timeouts, etc. for the sniff mode (e.g., Sniff_Max_Interval, Sniff_Min_Interval, Sniff_Attempt, Sniff_Timeout) as defined in the Bluetooth standard.

In response to receiving the HCI_Sniff_Mode message 212, the Controller-A 204 may reply with an HCI_Command_Status message 214, sent via the HCI, to the Host A 202. The HCI_Command_Status message 214 acknowledges receipt of the HCI_Sniff_Mode message 212 and acknowledges that the Controller-A 204 is fulfilling the request specified in the HCI_Sniff_Mode message 212 (namely, entering into sniff mode for the identified link).

The Controller-A 204 transmits an LMP_SNIFF_REQ message 216 to Controller-B 206 of the second device on the opposite side of the link identified in the HCI_Sniff_Mode message 212. The LMP_SNIFF_REQ message 216 is a request from Controller-A 204 to Controller-B 206 to enter sniff mode for their link. The LMP_SNIFF_REQ message 216 includes the parameters specified in the HCI_Sniff_Mode message 212. The Controller-B 206 may reply to the LMP_SNIFF_REQ message 216 with an LMP_ACCEPTED message 218 indicating acceptance of the sniff mode request from Controller-A 204. With the request to enter sniff mode accepted by the Controller-B 206, the sniff mode for the link starts 220.

Upon starting the sniff mode, the Controller-A 204 transmits an HCI_Mode_Change event message 224 to the Host A 202, and Controller-B 206 transmits an HCI_Mode_Change event message 226 to the Host B 208. The HCI_Mode_Change event messages inform the respective hosts that the link has entered into a sniff mode.

In some implementations, in conjunction with sending the HCI_Sniff_Mode message 212, Host A 202 initiates a timer for waiting for an event message (e.g., HCI_Mode_Change message 224) indicating that the link has changed to sniff mode. If the HCI_Mode_Change message 224 is received by the Host A 202 within the time period of the timer, then Host A 202 knows that the link is in sniff mode. Otherwise, the sniff mode request (in HCI_Sniff_Mode message 212) of the Host A 202 times out, and Host A 202 may send another HCI_Sniff_Mode message to restart the process of switching the link to sniff mode. During the period of the timer when the Host A 202 is waiting for the HCI_Mode_Change message 224, the computing system 100 may be hindered from going into sleep mode. For example, the software and/or hardware (e.g., operating system, system-on-chip) implementing the Host A 202 may require that the first device be awake from sleep mode in order for the Host A 202 to be ready to receive event messages, such as HCI_Mode_Change message 224.

In some implementations, when the Controller-B 206 at the second device receives the LMP_SNIFF_REQ message 216 while the second device is in sleep mode, the Controller-B 206 typically wakes the second device from sleep mode, so that the Host B 208 can be ready to receive a mode change event message (e.g., HCI_Mode_Change message 226). For example, the Controller-B 206 may trigger a wake-up process for the second device (e.g., assert a wakeup pin of a processor of the second device). The Controller-B 206 may then wait for the Host B 208 to be woken up from sleep mode to send the HCI_Mode_Change event message 226. Similarly to Host A 202 described above, the software and/or hardware (e.g., operating system, system-on-chip) implementing the Host B 208 may require that the second device be awake from sleep mode in order for the Host B 208 to be ready to receive event messages, such as HCI_Mode_Change message 226. If the second device is paired with multiple systems or devices via respective Bluetooth wireless links, then the sleep mode of the second device may be interrupted whenever any of those multiple systems or devices sends an LMP_SNIFF_REQ message to the second device.

For exiting sniff mode (e.g., to switch to active mode), the hosts 202 and 208, and controllers 204 and 206 may perform a messaging sequence that is similar to the message sequence 200 and which is also specified in the Bluetooth protocol standard.

Various components of the computing system 100 may be capable of operating in a reduced power state, such as a sleep mode (suspend to RAM), in order to conserve power. This may be particularly important when the computing system 100 is battery-powered, which is common for mobile devices such as cellular phones, tablet computers, and so on. However, as discussed above, a host module may be hindered from operating in a sleep mode when handling a switch to sniff mode for a Bluetooth link. For example, a device may be hindered from switching to sleep mode while a host module of the device is waiting for a mode change event message indicating that a link is in sniff mode. Similarly, if a device is in sleep mode and a controller module of the device receives an LMP_SNIFF_REQ message, the controller module may wake the device from sleep mode so that the host module of the device can be ready to receive a mode change event message from the controller module. This causes interruptions to the sleep mode on the device, resulting in reduced power savings.

Aspects of the present disclosure may improve the power savings at a device from implementing a sleep mode by configuring a controller module of the device to initiate and control a mode of operation for a wireless communication link (e.g., a Bluetooth link) on behalf of a host module of the device, and disregarding involvement of the host module in the initiation and control of the mode of operation for the link. This may be called “offloading” the initiation and control of the mode of operation (which may be referred to as “offloading mode control” in short) from the host module to the controller module. By disregarding the involvement of the host module in the mode control, the device may go into a sleep mode or remain in a sleep mode while still being capable of controlling the mode of operation of a wireless communication link.

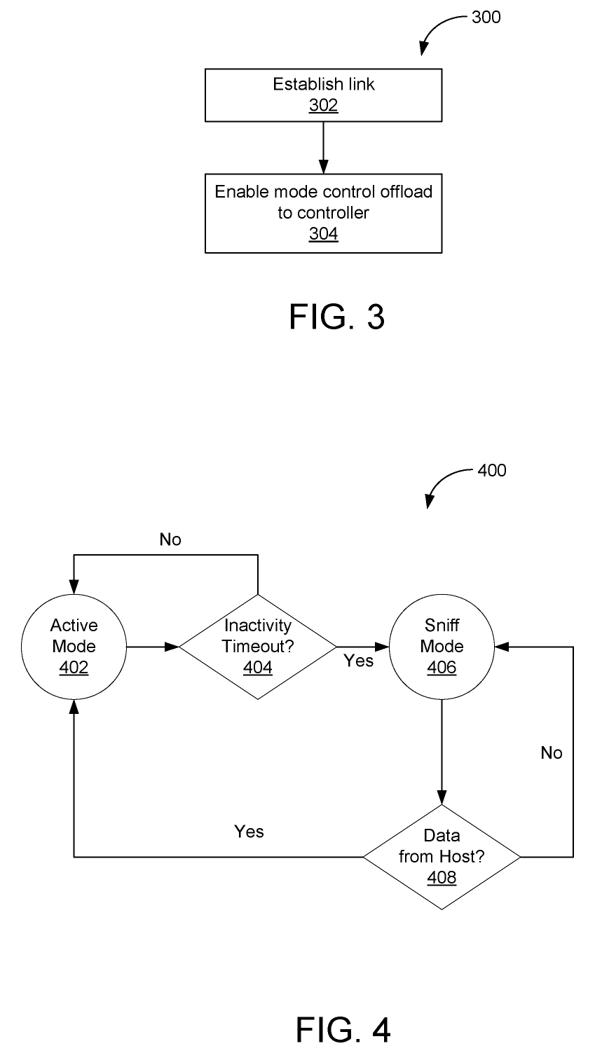

FIG. 3 shows an illustrative flow chart depicting an example operation for configuring a device to offload mode control to a controller, according to some implementations. FIG. 3 illustrates a process 300 by which a device (e.g., a host module) offloads mode control to a controller module. In some implementations, the process 300 may be performed by a computing system (e.g., computing system 100) with a host module and a controller module (e.g., host module 110 and controller module 114, respectively).

As shown, process 300 begins with step 302, where the computing system 100 establishes a wireless link (e.g., a Bluetooth link 150) with another device (e.g., a paired device 130). The wireless communication core 102 may establish the link 150 in accordance with the procedures specified in the wireless communication protocol (e.g., Bluetooth) implemented by the wireless communication core 102. For example, the computing system 100 may establish a link 150 with the device 130 as part of a process of pairing with the device 130.

In step 304, a host (e.g., the host module 110) enables mode control offload to a controller (e.g., the controller module 114). The host module 110 sends a command or a message, via the HCI 112, to the controller module 114 to enable mode control offload for any link associated with the computing system 100, including the link established in step 302, in effect instructing the controller module 114 to control the modes of operation for wireless links associated with the computing system 100 and disregard the host module 110 in the mode control. Alternatively, in some implementations, the controller module 114 sends the command or message, via the HCI 112, to the host module 110 to assert offload of mode control from the host module 110 to the controller module 114.

In some implementations, the wireless communication core 102 implements one or more vendor-specific commands associated with mode control offloading. The host module 110 may send, and the controller module 114 may receive, these vendor-specific commands. In implementations where the controller module 114 may assert offload of mode control, the controller module 114 may send, and the host module 110 may receive, one or more vendor-specific commands as well. The one or more vendor-specific commands associated with mode control offloading may include a mode control offload command, optionally a mode control offload assertion command (for asserting offload of mode control by the controller module), and optionally a mode control parameter command.

The mode control offload command may specify one or more parameters that are the same as in the HCI_Sniff_Mode message (e.g., Sniff_Max_Interval, Sniff_Min_Interval, Sniff_Attempt, and Sniff_Timeout). These specified parameters may serve as default parameters for a sniff mode controlled by the controller module 114. The mode control offload command may further include an indicator specifying enablement of mode control offload, and a link activity timeout parameter that specifies a threshold duration for inactivity on a link. That is, a condition for switching a link to sniff mode is met if the link is inactive for at least the threshold duration specified by the link activity timeout parameter. The controller module 114 may thus control the mode of operation for any link associated with the computing system 100 and established according to the wireless communication protocol, including detecting inactivity time based on the link activity timeout parameter. In some implementations, a mode control offload assertion command may include similar parameters as the mode control offload command described above.

In some implementations, the host module 110 may send the mode control offload command before a link is established, thereby reversing the order of steps 302 and 304 in process 300. For example, the host module 110 may send the mode control offload command when wireless communications (e.g., Bluetooth) at the computing system 100 is turned on or when the computing system 100 powers on. In some other implementations, the host module 110 may send the mode control offload command in conjunction with establishing a first link after wireless communications at the computing system 100 is turned on.

In some implementations, the host module 110 may update the parameters for mode control with respect to a specific link. The host module 110 may send a mode control parameter command to the controller module 114 via the HCI 112. The mode control parameter command may include a connection handle identifying the link for which the updated parameters are applicable (replacing the default parameters specified in the vendor-specific mode control offload command), and updated parameters (e.g., updated values for Sniff_Max_Interval, Sniff_Min_Interval, Sniff_Attempt, Sniff_Timeout, and/or link activity timeout). The controller module 114 receives this mode control parameter command and uses the updated parameters included therein for mode control for the link identified therein. In some implementations, the controller module 114 (e.g., Controller-A 204 in FIG. 2), in response to receiving the mode control parameter command, may transmit an LMP_SNIFF_REQ message (similar to LMP_SNIFF_REQ message 216) to a controller module of the paired device 130 (e.g., Controller-B 206 in FIG. 2) to re-negotiate the sniff mode based on the updated parameters.

As described above, with mode control offloaded to the controller module 114, involvement of the host module 110 in controlling the mode for a link may be disregarded. Thus, returning to FIG. 2, with mode control at the first and second devices offloaded to the controllers Controller-A 204 and Controller-B 206 respectively, Host A 202 may omit sending the HCI_Sniff_Mode message 212. Alternatively, Host A 202 may send the HCI_Sniff_Mode message 212 in accordance with the Bluetooth standard, but the Controller-A 204 may disregard the HCI_Sniff_Mode message 212. The Controller-A 204 may omit sending the HCI_Command_Status message 214 to the Host A 202. Further, Controller-A 204 and Controller-B 206 may omit sending the HCI_Mode_Change event message 224 to the Host A 202 and the HCI_Mode_Change event message 226 to the Host B 208, respectively. By omitting sending the HCI_Mode_Change event messages 224 and 226, the devices corresponding to the host modules need not remain in a normal power mode (e.g., hindered from entering sleep mode) in order for the host modules to wait for a HCI_Mode_Change message. Further, the devices need not be woken up from sleep mode in order for the host modules to be ready to receive a HCI_Mode_Change message. That is, the Controller-A 204 and Controller-B 206 may exchange the LMP messages 216 and 218, and sniff mode may start 220, while their respective corresponding devices are in sleep mode.

It should be appreciated that mode control offloading may be implemented and/or in effect on one or both devices of a pair of devices (e.g., computing system 100 and paired device 130) paired via a link (e.g., link 150). That is, the offloading techniques described herein may be implemented on one or both of the devices paired via the link. Further, even if mode control offloading techniques are implemented on both devices, each of the paired devices may offload mode control or cease such an offload independently of whether the other device of the pair has offloaded mode control or not.

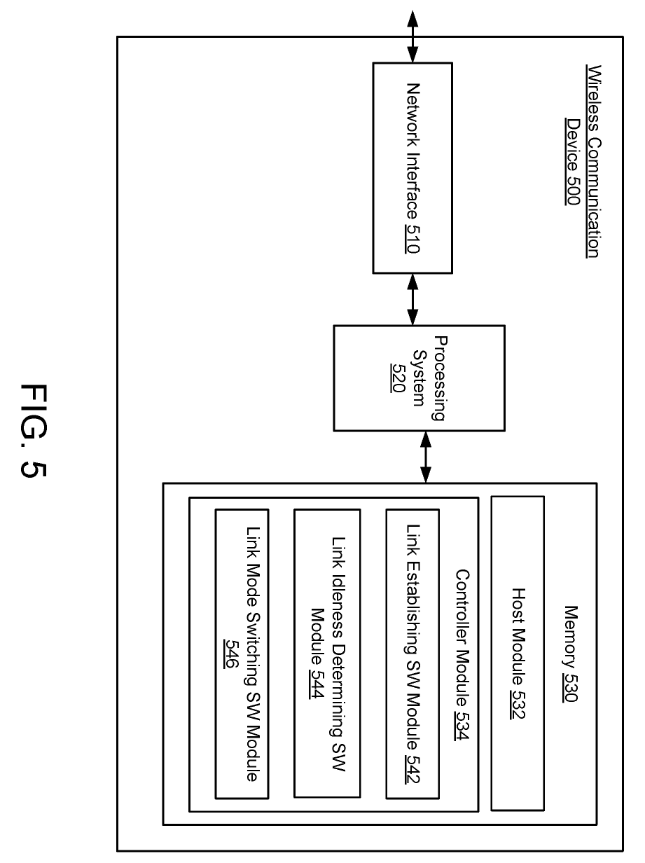

FIG. 4 shows an illustrative diagram depicting an example operation for a controller switching between an active mode and a sniff mode for a Bluetooth link, according to some implementations. FIG. 4 illustrates a state or mode diagram 400 illustrating active and sniff modes for a link and decision points for switching modes, as operated by a controller (e.g., controller module 114) with mode control offload enabled.

When a link (e.g., link 150) is established, the link starts in active mode 402. Under mode control offload, the controller module 114 monitors the link for activity and periods of inactivity based on the link inactivity timeout parameter. The controller module 114 determines, at decision 404, whether the link has been inactive for at least the threshold duration specified by the link inactivity timeout parameter is met. If the link has been inactive for at least the threshold duration (e.g., the current period of inactivity is not long enough, there is incoming data from the host module 110 to send over the link, etc.), then the controller module 114 maintains active mode 402 for the link (404 – No). If the link has been inactive for at least the threshold duration, then the controller module 114 switches the link to sniff mode 406 (404 – Yes). For example, the controller modules of the computing system 100 and the paired device 130 exchange messages 216 and 218 and start sniff mode 220 for the link, as in messaging sequence 200, but without involvement of the host modules (e.g., messages 212, 214, 224, and 226 are not sent).

While in sniff mode 406, the controller module 114 may monitor conditions for switching back to active mode 402. At decision 408, the controller module 114 determines whether it has received any data from the host module 110 over the HCI 112 (e.g., data to be sent to the paired device 130, ACL data from the host module 110, a mode control parameter command from the host module 110). If the controller module 114 has not received data from the host module 110, the controller module 114 may maintain the sniff mode (408 – No). If the controller module 114 has received data from the host module 110, the controller module 114 switches to active mode 402 (408 – Yes). When the controller module 114 switches to active mode, the controller module 114 may send a message to the host module 110 indicating the switch and/or wake up the computing system 100 (if the computing system 100 is in sleep mode).

FIG. 5 shows a block diagram of example wireless communication device 500, according to some implementations. In some implementations, the wireless communication device 500 may be an example of the computing system 100 of FIG. 1. In some implementations, host module 532 corresponds to host module 110 of FIG. 1, and controller module 534 corresponds to controller module 114 of FIG. 1.

The wireless communication device 500 includes network interface 510, a processing system 520, and a memory 530. The network interface 510 may include one or more interfaces for communicating, via wired or wireless connections, with remote devices and networks, such as one or more local area networks, wide area networks, cellular networks, communicating with one or more local devices such as paired device 130 using one or more short range wireless protocols, and so on. More particularly, with respect to the present disclosure, the network interface 510 may establish a pairing (e.g., a link 150) with another wireless communication device (e.g., paired device 130).

The memory 530 may include a non-transitory computer-readable medium (including one or more nonvolatile memory elements, such as EPROM, EEPROM, Flash memory, or a hard drive, among other examples). The memory 730 may also store at least the following modules:
a host module 532 to implement a host stack associated with a wireless communication protocol (e.g., host layer(s) of the Bluetooth protocol); and
a controller module 534 to implement a controller stack associated with the wireless communication protocol (e.g., controller layer(s) of the Bluetooth protocol).

The controller module 534 may include at least the following software (SW modules):
a link establishing SW module 542 to establish a link with another wireless communication device;
a link idleness determining SW module 544 to determine that the link is idle for at least a threshold duration; and
a link mode switching SW module 546 to switch between an active mode associated with the link and a sniff mode associated with the link without sending to the host module 532 a message associated with the switching between the active mode and the sniff mode, or to, in response to determining that the link is idle for at least the threshold duration, switch a mode of operation associated with the link, from an active mode to a sniff mode, without sending to the host module 532 a message associated with the switching to the sniff mode.

Each software module includes instructions that, when executed by the processing system 520, causes the wireless communication device 500 to perform the corresponding functions.

The processing system 520 may include any suitable one or more processors capable of executing scripts or instructions of one or more software programs stored in the wireless communication device 500 (such as in the memory 530). For example, the processing system 520 may execute the link establishing SW module 542 to establish a link with another wireless communication device. Similarly, the processing system 520 may execute the link idleness determining SW module 544 to determine that the link is idle for at least a threshold duration.

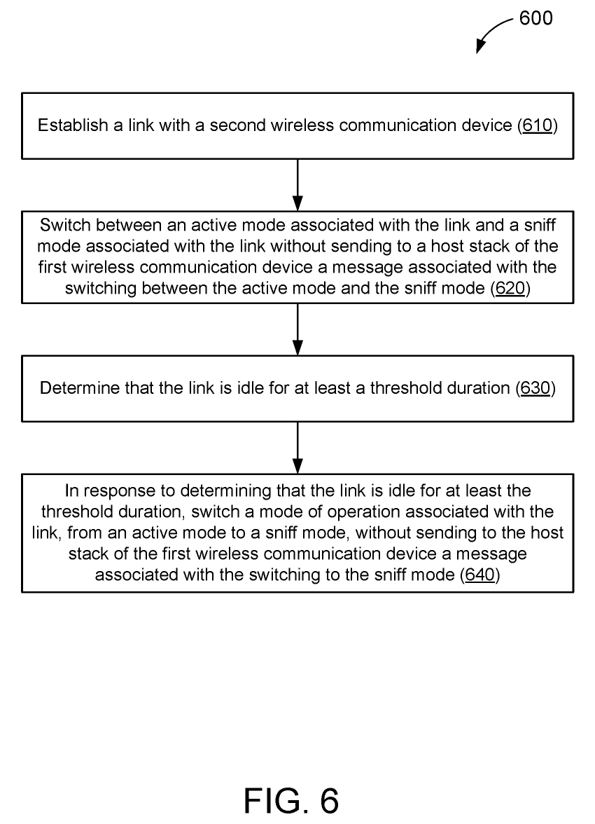

FIG. 6 Illustrates a flowchart depicting an example method 600 of controlling a mode of operation of a wireless communication link, according to some implementations. The method 600 may be performed by a first wireless communication device (e.g., computing system 100), in particular a controller implementing a controller stack (e.g., controller module 114) of the first wireless communication device, as discussed above with reference to FIGS. 1 and 3-4.

As illustrated, at block 610, a controller of the first wireless communication device establishes a link with a second wireless communication device. At block 620, the controller switches between an active mode associated with the link and a sniff mode associated with the link without sending to a host stack of the first wireless communication device a message associated with the switching between the active mode and the sniff mode. At block 630, the controller determines that the link is idle for at least a threshold duration.

At block 640, in response to determining that the link is idle for at least the threshold duration, the controller switches a mode of operation associated with the link, from an active mode to a sniff mode, without sending to the host stack of the first wireless communication device a message associated with the switching to the sniff mode.

In some aspects, the controller may establish the link based on a Bluetooth wireless communication protocol, wherein the active mode and the sniff mode are associated with the Bluetooth wireless communication protocol.

In some aspects, the controller may determine that a condition for switching the mode of operation associated with the link to the active mode is met; and based on the determination that the condition for switching to the active mode is met, switch the mode of operation associated with the link from the sniff mode to the active mode.

In some aspects, the condition for switching to the active mode includes the controller receiving data for transmission to the second wireless communication device over the link.

In some aspects, the controller may, while the mode of operation associated with the link is the active mode, receive first data to be transmitted to the second wireless communication device or second data transmitted from the second wireless communication device; and based on receiving the first data or the second data, maintaining the mode of operation associated with the link in the active mode.

In some aspects, the controller may, while the mode of operation associated with the link is the sniff mode, receive data from the host stack; and based on receiving the data from the host stack, switch the mode of operation associated with the link from the sniff mode to the active mode.

In some aspects, the controller omits sending a mode change event to the host stack indicating the switching from the active mode to the sniff mode.

In some aspects, the first wireless communication device is in a sleep mode prior to the switching of the mode of operation associated with the link, and the first wireless communication device remains in the sleep mode concurrently with the switching of the mode of operation associated with the link from the active mode to the sniff mode.

In some aspects, the controller may send a sniff mode request message to the second wireless communication device, and the first wireless communication device remains in the sleep mode concurrently with the sending of the sniff mode request message.

In some aspects, the controller may receive a sniff mode request acceptance message from the second wireless communication device, and the first wireless communication device remains in the sleep mode concurrently with the receiving of the sniff mode request acceptance message.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the disclosure.

The methods, sequences or algorithms described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

In the foregoing specification, embodiments have been described with reference to specific examples thereof. It will, however, be evident that various modifications and changes may be made thereto without departing from the broader scope of the disclosure as set forth in the appended claims. The specification and drawings are, accordingly, to be regarded in an illustrative sense rather than a restrictive sense.

What is claimed is:

1. A method performed by a controller of a first wireless communication device, comprising:
establishing a link with a second wireless communication device;
switching between an active mode associated with the link and a sniff mode associated with the link without sending to a host stack of the first wireless communication device a message associated with the switching between the active mode and the sniff mode;
determining that the link is idle for at least a threshold duration; and
in response to determining that the link is idle for at least the threshold duration, switching a mode of operation associated with the link, from an active mode to a sniff mode, without sending to the host stack of the first wireless communication device a message associated with the switching to the sniff mode.

2. The method of claim 1, wherein the establishing of the link comprises establishing the link based on a Bluetooth wireless communication protocol, wherein the active mode and the sniff mode are associated with the Bluetooth wireless communication protocol.

3. The method of claim 1, further comprising:
determining, by the controller, that a condition for switching the mode of operation associated with the link to the active mode is met; and
based on the determination that the condition for switching to the active mode is met, switching, by the controller, the mode of operation associated with the link from the sniff mode to the active mode.

4. The method of claim 3, wherein the condition for switching to the active mode includes receiving, by the controller, data for transmission to the second wireless communication device over the link.

5. The method of claim 3, further comprising:
while the mode of operation associated with the link is the active mode, receiving, by the controller, first data to be transmitted to the second wireless communication device or second data transmitted from the second wireless communication device; and
based on receiving the first data or the second data, maintaining, by the controller, the mode of operation associated with the link in the active mode.

6. The method of claim 1, further comprising:
while the mode of operation associated with the link is the sniff mode, receiving, by the controller, data from the host stack; and
based on receiving the data from the host stack, switching, by the controller, the mode of operation associated with the link from the sniff mode to the active mode.

7. The method of claim 1, wherein the controller omits sending a mode change event to the host stack indicating the switching from the active mode to the sniff mode.

8. The method of claim 1, wherein the first wireless communication device is in a sleep mode prior to the switching of the mode of operation associated with the link, the first wireless communication device remaining in the sleep mode concurrently with the switching of the mode of operation associated with the link from the active mode to the sniff mode.

9. The method of claim 8, further comprising sending, by the controller, a sniff mode request message to the second wireless communication device, the first wireless communication device remaining in the sleep mode concurrently with the sending of the sniff mode request message.

10. The method of claim 9, further comprising receiving, by the controller, a sniff mode request acceptance message from the second wireless communication device, the first wireless communication device remaining in the sleep mode concurrently with the receiving of the sniff mode request acceptance message.

11. A first wireless communication device, comprising:
a host module; and
a controller module configured to:
establish a link with a second wireless communication device;
switch between an active mode associated with the link and a sniff mode associated with the link without sending to the host module a message associated with the switching between the active mode and the sniff mode;
determine that the link is idle for at least a threshold duration; and
in response to determining that the link is idle for at least the threshold duration, switch a mode of operation associated with the link, from an active mode to a sniff mode, without sending to the host module a message associated with the switching to the sniff mode.

12. The first wireless communication device of claim 11, wherein the controller module is configured to establish the link based on a Bluetooth wireless communication protocol, wherein the active mode and the sniff mode are associated with the Bluetooth wireless communication protocol.

13. The first wireless communication device of claim 11, wherein the controller module is configured to:
determine that a condition for switching the mode of operation associated with the link to the active mode is met; and
based on the determination that the condition for switching to the active mode is met, switch the mode of operation associated with the link from the sniff mode to the active mode.

14. The first wireless communication device of claim 13, wherein the condition for switching to the active mode includes receiving, by the controller module, data for transmission to the second wireless communication device over the link.

15. The first wireless communication device of claim 13, wherein the controller module is configured to:
while the mode of operation associated with the link is the active mode, receive first data to be transmitted to the second wireless communication device or second data transmitted from the second wireless communication device; and
based on receiving the first data or the second data, maintaining the mode of operation associated with the link in the active mode.

16. The first wireless communication device of claim 11, wherein the controller module is configured to:
while the mode of operation associated with the link is the sniff mode, receive data from the host module; and
based on receiving the data from the host module, switch the mode of operation associated with the link from the sniff mode to the active mode.

17. The first wireless communication device of claim 11, wherein the controller module is configured to omit sending a mode change event to the host module indicating the switching from the active mode to the sniff mode.

18. The first wireless communication device of claim 11, wherein the first wireless communication device is in a sleep mode prior to the switching of the mode of operation associated with the link, and the first wireless communication device remains in the sleep mode concurrently with the switching of the mode of operation associated with the link from the active mode to the sniff mode.

19. The first wireless communication device of claim 18, wherein the controller module is configured to send a sniff mode request message to the second wireless communication device, the first wireless communication device remaining in the sleep mode concurrently with the sending of the sniff mode request message.

20. The first wireless communication device of claim 19, wherein the controller module is configured to receive a sniff mode request acceptance message from the second wireless communication device, the first wireless communication device remaining in the sleep mode concurrently with the receiving of the sniff mode request acceptance message.
